(19) United States
(12) Patent Application Publication
(10) Pub. No.: US 2019/0079913 A1
(43) Pub. Date: Mar. 14, 2019

(54) REGULATORY COMPLIANCE SYSTEM

(71) Applicant: Xerox Corporation, Norwalk, CT (US)

(72) Inventors: Jonathan D. Levine, Rochester, NY (US); Larry R. Glass, Pittsford, NY (US); Michael Patrick Wiseman, Webster, NY (US); Ray Uri Merriam, Rochester, NY (US); Stephen K. Korndoerfer, West Henrietta, NY (US); Joseph St. Germaine, Fairport, NY (US)

(73) Assignee: Xerox Corporation, Norwalk, CT (US)

(21) Appl. No.: 15/698,998

(22) Filed: Sep. 8, 2017

(51) Int. Cl. G06F 17/24; G06Q 50/18; G06Q 10/10

(52) U.S. Cl. CPC G06F 17/243; G06Q 10/10; G06Q 50/184

(57) ABSTRACT

A method and system for regulatory compliance aggregates a set of report forms in a repository. Each report form is associated with one or more regulatory agencies. In response to a request for the compliance data of a product that is going to market, the system matches the product to the relevant form(s) in the repository. The system then guides the steps of populating and completion of regulatory compliance reports for each vendor (corresponding to the different source materials or operation used in producing the product or service) in the value chain. On a vendor-by-vendor basis, the system selectively redacts proprietary information from the compliance report, and transmits the partially redacted compliance report to the other vendors that are cooperating in the product production. Further, the system completes a report for each agency involved in the marketing and, more particularly, transmits only the data required by a corresponding agency thereto.

### BACKGROUND

The present disclosure relates to a method for regulatory compliance and, more specifically, to guiding the process of populating regulatory compliance forms while reducing duplicative efforts. Where a compliance report includes intellectual property information, the present disclosure further guides the regulatory compliance process to ensure that the intellectual property information remains confidential and is made only selectively available to the regulators that require the information for approving a product or service. The present disclosure is anticipated for use in manufacturing value chains, but is amenable to other public and private sectors as well.

Agencies of multiple levels regulate the products and services that enter commerce. The regulations help ensure that the products or services (collectively referred to hereinafter as “product”) are safe and effective. The process for reporting product information and ensuring that the products comply with related requirements is referred to herein as “regulatory compliance”. The regulations can also change over time—i.e., they can get stricter or more relaxed. At the most basic level, regulatory compliance is an exercise of filling out forms. However, it gets more complex when there are a number of participants each reporting in a value chain. For any end-product, there can be multiple participants in the supply chain that cooperate to create the product. For example, the manufacturers are regulated on the materials used to produce the various sub-parts forming the product, while the printer (or supplier of the ink) is separately regulated on the ink involved in labeling the product. Each participant is regulated in its own capacity, but the final distributor cannot introduce the product in commerce until each participant in the supply chain has complied with its regulations. Furthermore, any one vendor may be required to report to multiple agencies. These relationships between vendors cooperating on a product, and the reporting structure among parties forming the relationships, is referred to herein as “supply chain management”.

To further complicate matters, the conventional process of simply filling out forms has not been sufficient to (for example) keep regulated chemicals from entering the environment. In January 2017, the EPA promulgated significant new use regulations under the Toxic Substances Control Act. Similar changes or new regulations are being introduced worldwide. The new rules have turned the conventional method of filling out forms into an enormous and cumbersome data analytics task.

FIG. 1 is an illustrative regulatory environment according to the PRIOR ART for a manufacturing value chain. FIG. 1 illustrates the kind of complexity that makes conventional systems difficult to maintain. FIG. 1, illustrating the relationships among various parties in a reporting structure, inhibits ease-of-use and user understanding, which can lead market participants to engage in behavior that is intended to sneak around or bypass the regulation(s). As viewable from the illustration, the volume of information makes it difficult to determine, for each regulator, which vendor has contributed to which product. This matter gets more complicated when a vendor replaces a manufacturer of a subpart midway through the production process. The manufacturer's contribution to the end-product must still be tracked, and be distinguished from the end-products including the previous manufacturer's parts.

The process gets more complicated when a participant up the supply chain reports to multiple agencies and to the participants farther down the supply chain. Regulatory compliance reporting exposes intellectual property and private data. Under certain conditions, a company's intellectual property or proprietary information may be exposed to other participants down the value chain. For example, proprietary information of the participant can be made viewable to competitors when other vendors down the chain can view the compliance reports. Particularly, this information can include trade secrets on ingredients used in forming a chemical or the steps that are performed in an operation used to produce an ingredient, among others.

An additional side effect caused by the new regulations is that regulators are not prepared to make use of, or handle, the amount of data that is being submitted. In other words, the regulators are or will be overwhelmed by the volume of data that it will receive as a result of the new regulations, which complicates the process for approval on the regulator's end.

The complexity of the conventional process competes with the need for a simpler approach that also allows for proprietary information to be reported to the regulatory agency in confidence. There is a need for a more adjudicated process for each end-user in the private and public sectors.

### BRIEF DESCRIPTION

One embodiment of the disclosure is directed to a method for guiding the process of regulatory compliance to radically simplify the process of populating the forms for end-users in the private sector. The method includes accessing a repository including a plurality of regulatory forms each corresponding to a participating agency, wherein each of the plurality of forms includes a plurality of data fields. At a server computer in communication with the repository, the method includes processing each form in the repository to generate a superset of all data fields required by all of the agencies. The method includes receiving from a user interface a new or renewing product or service submission. From the product/service identified in the submission, the method includes determining compliance requirements that the product or service must satisfy before entering commerce. The method includes determining at least one form corresponding to the requirements. The method includes acquiring from the repository the at least one form. The method includes populating user information in the data fields of the at least one form to generate at least one regulatory compliance report. The method includes transmitting the at least one regulatory compliance report to a corresponding agency computing device.

Another embodiment of the disclosure is directed to a system for populating regulatory forms. The system includes a repository comprising a plurality of regulatory forms each corresponding to a participating agency. Each of the plurality of forms includes a plurality of data fields. The system includes a server computer in communication with the repository. The server computer includes a memory storing instructions and a processor programmed to execute the instructions. The processor is operative to process each form in the repository to generate a superset of all data fields required by all of the agencies. The processor is further operative to receive from a user interface a new or renewing product or service submission. From the product or service identified in the submission, the processor determines compliance requirements that the product or service must satisfy before entering commerce. The processor is operative to determine at least one form corresponding to the requirements; acquire from the repository the at least one form; and populate user information in the data fields of the at least one form to generate at least one regulatory compliance report. The processor is operative to transmit the at least one regulatory compliance report to a corresponding agency computing device.

Another element of the disclosure is a system and method of delivering appropriate data to appropriate regulators for evaluation. Different regulators require different subsets of data from the various value chain participants. The current disclosure delivers data to a particular regulatory agency, and more specifically transmits only the data required from a particular value chain participant to the agency. By this, the regulator also benefits from a reduced volume of information and is not required to process information that it does not need.

Another element of the disclosure is a system and method to enable only authorized private and public sector participants to see any particular piece of data submitted by any of the private sector participants. In other words, the various parties interacting with the present system have access to only the information that they are authorized to view or need to perform their tasks or obligations.

### BRIEF DESCRIPTION OF THE DRAWINGS

FIG. 1 is an illustrative regulatory environment according to the PRIOR ART for a manufacturing value chain.

FIG. 2 is a schematic showing a computer-implemented system for regulatory compliance.

FIGS. 3A-3C illustrate an exemplary method which can be performed with the system of FIG. 2.

FIG. 4 is an illustrative regulatory environment according to the present disclosure for the manufacturing value chain of FIG. 3.

FIGS. 5A-5B is an illustrative reporting structure for the system of FIG. 2.

FIGS. 6A-6B, 7A-7B, and 8A-8B are sample reporting structures for illustrative purposes.

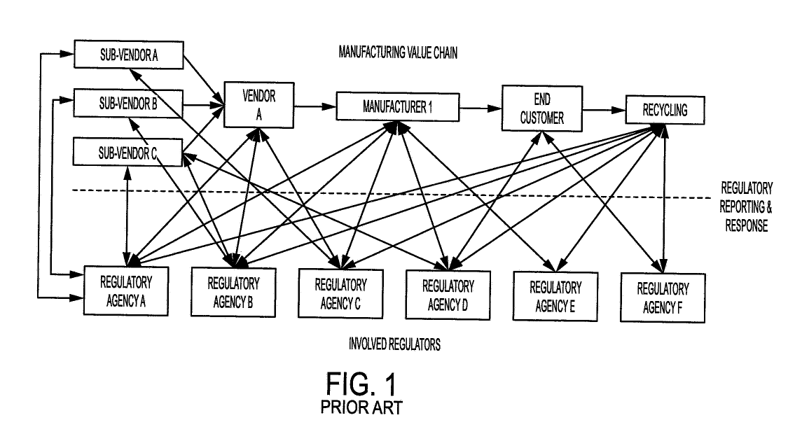

### DETAILED DESCRIPTION

In general, embodiments of the disclosure provide a method and system for regulatory compliance and particularly for guiding the process of populating and reporting a compliance record form. In general, embodiments of the disclosure aggregate a set of report forms in a repository. Each report form may be associated with one or more regulatory agencies. After aggregating the forms, a request for the compliance data of a product that is going to be introduced into commerce is received by the system. In other embodiments, the request can be received for updating the reports for products and/or services that are already in commerce, as such products may require updating at regulated intervals. The request may include a location of the product or service, which is matched to the relevant agencies. The agencies are then matched to the relevant form(s) in the repository. The system then populates a regulatory compliance report for a source material or operation used in producing the product or service. On a vendor-by-vendor basis, the system selectively redacts proprietary information from the compliance report, and transmits the partially redacted compliance report to the vendor cooperating in the introduction of the new product, farther down the supply chain.

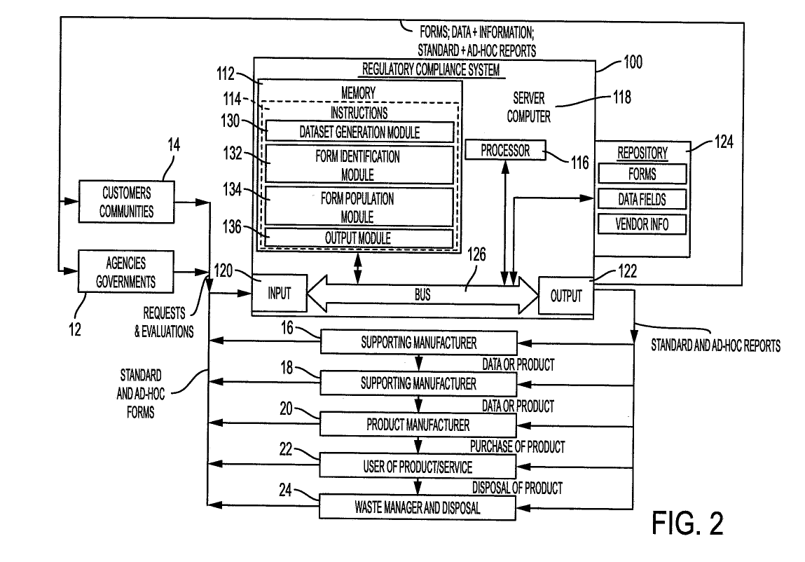

FIG. 2 is a schematic showing a computer-implemented system for regulatory compliance and the various parties that can interact with the regulatory compliance system (the “RPC system”) 100. In the public sector, national regulatory agencies, regional agencies and local/municipal governments are anticipated users of the system. Also in the public sector, customers and communities are anticipated users of the system. These parties are collectively referred to herein with “agencies” for ease of description. An “agency” can be synonymous with a regulator—a party that issues laws, rules, or regulates an industry—as used herein. Through an interface in communication with an agency computing device 12, 14, the agencies can selectively and independently transmit requests for completed forms and, in one embodiment, the agencies can transmit evaluations (e.g., approval) of completed compliance reports that are received from the system. The agency computing device(s) 12, 14 can receive completed or ad-hoc compliance reports including vendor information populated in the data fields of the reports. By “ad-hoc” compliance reports, the disclosure means reports with information selectively redacted therefrom.

Through an interface in communication with a vendor computing device 106, the RCS system is in electronic communication with one or more value chain partners. As used herein, a value chain partner can mean a supporting manufacturer (e.g., 16, 18); an end-product manufacturer 20; a user 22 of the product or service; and a disposer or waste manager 24 of the product, among other parties in the supply chain. The value chain partners (hereinafter collectively referred to as “vendors”) can submit the information that is required for populating the data fields in the forms. Each vendor can receive the completed reports—or redacted copies of the completed reports—of other vendors up or down the supply chain. The disclosure anticipates the private sector participants—meeting emerging regulatory requirements—as users of the system

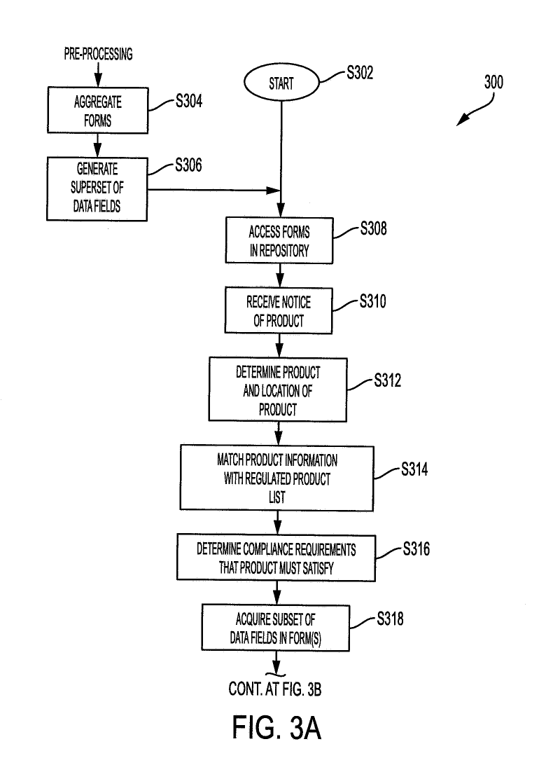

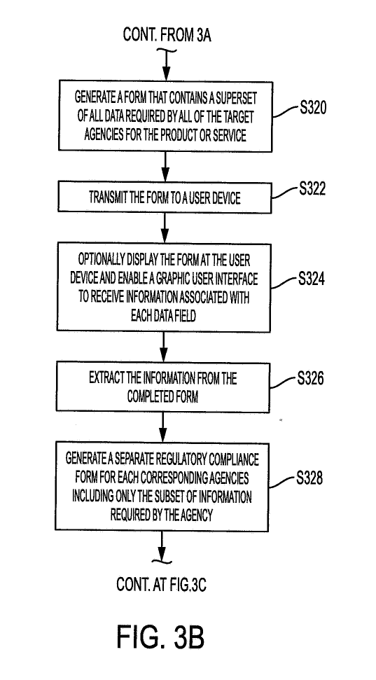

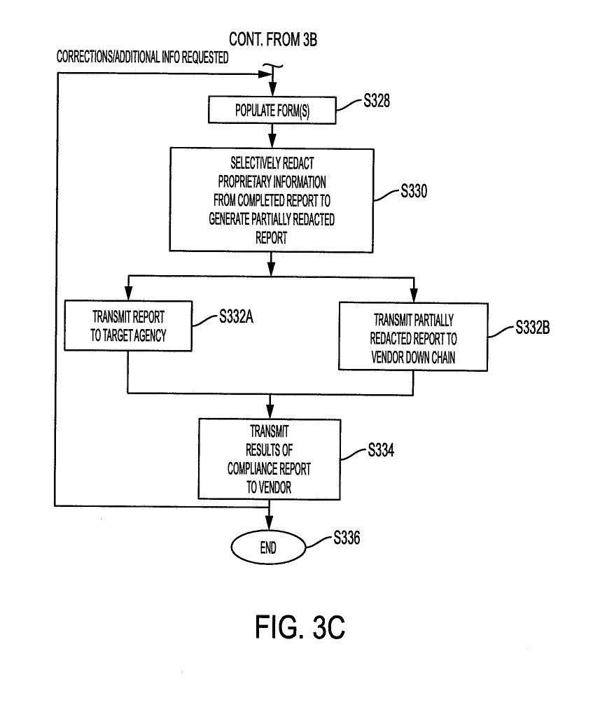

With continued reference to FIG. 2, the RCS system 100 includes memory 112 which stores instructions 114 for performing the method illustrated in FIG. 3 and a processor 116 in communication with the memory for executing the instructions. The RCS system 100 may include one or more computing devices, such as the illustrated server computer 118. One or more input/output devices 120, 122 allow the system 100 to communicate with external devices, such as a user devices 12-24 via wired or wireless links, such as a LAN or WAN, such as the Internet. In one embodiment, the server computer 118 receives regulatory forms each corresponding to a participating agency.

In one embodiment, the data fields are extracted from all forms to generate a superset of data fields stored in a repository 124 in communication with the system. In one embodiment, agencies can supply the forms to the RCS system 100 for processing. Hardware components 122, 116, 120, 122 of the RCS system 100 communicate via a data/control bus 126.

The illustrated instructions 114 include a dataset generation module 130, a form identification module 132; a form population module 134; and an output module 136.

The dataset generation module 130 generates a superset of all data fields included in the acquired forms. Further, the module 130 extracts a request for information corresponding to each data field from the plurality of regulatory forms; removes duplicate requests in the superset of data fields. While processing a request for a specific form, in one embodiment the dataset generation module can generate a subset of data fields required by all the regulatory agencies that regulate a selected product or service.

The form identification module 132 determines compliance requirements that the product or service must satisfy before entering commerce. Module 132 also identifies at least one form corresponding to the requirements. The form population module 132 populates user information in the data fields of the at least one form to generate a regulatory compliance report. The module 132 also selectively redacts information in the regulatory compliance report on a vendor-by-vendor basis.

The output module 134 provides the generated report to a user device.

The modules are software applications or a set of software applications executing on one or more hardware processors. The software application may be a web application in a server of a data center and/or cloud computing application in a network distributed system. Alternatively, the modules may be a software application residing on a user computing device. The computer system 100 may include one or more computing devices, such as a PC, such as a desktop, a laptop, palmtop computer, portable digital assistant (PDA), server computer, cellular telephone, tablet computer, pager, a scanner, and combinations thereof, or other computing device capable of executing the instructions for performing the exemplary method. The components of the system may be located on the same device or on separate devices connected to a network (e.g., the Internet, with wired and/or wireless segments.

The memory 112 may represent any type of non-transitory computer readable medium such as random access memory (RAM), read only memory (ROM), magnetic disk or tape, optical disk, flash memory, or holographic memory. In one embodiment, the memory 112 comprises a combination of a random access memory and read only memory. In some embodiments, the processor 116 and memory 112 may be combined in a single chip. Memory 112 stores instructions for performing the exemplary method as well as the processed data.

The network interface 120, 122 allows the computer to communicate with other devices via a computer network, such as a local area network (LAN) or wide area network (WAN), or the internet, and may comprise a modulator/demodulator (MODEM), a router, a cable, and/or Ethernet port.

The digital processor device 116 can be variously embodied, such as by a single-core processor, a dual-core processor (or more generally by a multiple-core processor), a digital processor and cooperating math coprocessor, a digital controller, or the like. The digital processor 116, in addition to executing instructions 114 may also control the operation of the computer 118.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

The repository 124 is a database or a storage application residing on one or more servers. The repository 124 can be a distributed database management system (or a component thereof), a clustered database, a standalone flat file, and/or any storage software residing on one or more physical storage devices. Examples of a storage device may include, but are not limited to, a hard disk drive, a tape drive, a redundant array of independent disks (RAID), and/or a solid state drive or memory drive. Any type of database or storage application can be used, in accordance with the various embodiments of the disclosure. The repository 124 is in communication with the RCS system and can also store a table associating regulatory forms with the corresponding agencies, products with the agencies that regulate them, or a combination of the above.

A method 300 for reporting regulatory forms is shown in FIGS. 3A-3C. The method starts at S302. Before the method is performed, as part of a pre-processing operation, the system acquires copies of regulatory forms from all agencies participating in the system at S304. The system aggregates a set of regulatory forms, each associated with one or more agencies. In the contemplated embodiment, the forms are templates for the information that each regulator needs from a vendor(s) before approving the product for market. The disclosure anticipates an RCS system that guides the handling of all regional forms covering local municipalities to nationwide and worldwide networks. The RCS system includes functionality to handle forms for all public and private sectors, governmental bodies, and agencies, and more specifically guides these parties' interaction with the system to simplify reporting and record maintenance.

In a further preprocessing operation, the system rationalizes the forms so that there are no repeated data fields. Each regulatory agency has different compliance requirements. For this reason, a vendor may be required to report to regional and national agencies. For the vendor that is required to complete multiple reports using the conventional process, there is some overlap to the questions that are asked across forms. For example, the name and address information, or identification information, is repeated across forms. At S306, the dataset generation module 130 extracts a request for information corresponding to each data field from all forms and generates a superset of data fields in the repository. The module 130 further filters the superset to discard any duplicative requests so that there is only one copy of each data field in the repository.

A copy of each form is stored in the repository. At S308, the RCS system accesses the repository comprising a plurality of regulatory forms each corresponding to a participating agency, wherein each of the plurality of forms comprises a plurality of data fields. At S310, the RCS system receives a request from a user interface in communication with the system. The request, or notice, involves a new product or an existing product, which needs updated information.

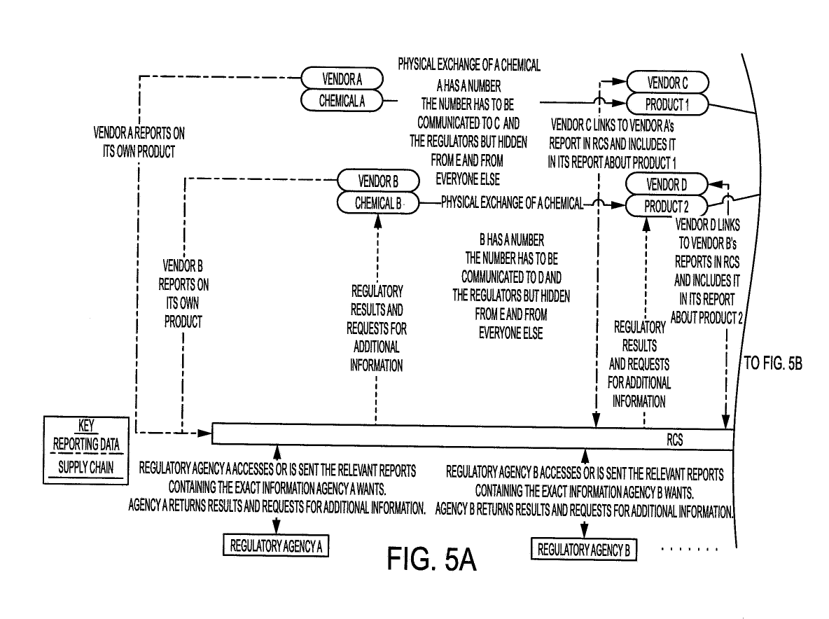

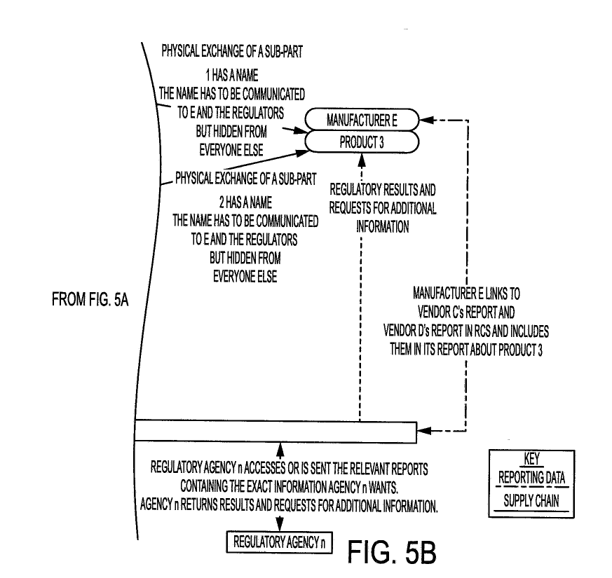

FIG. 5 is an illustrative reporting structure for the embodiments described in connection with the method of FIGS. 3A-3C. The reporting is localized. The request can be received from an agency computing device (Regulatory Agency A . . . n, FIG. 5) asking for a copy of a completed report form, or more simply information on the product. In another embodiment, the request can be received from an end-user computing device, wherein the end-user computing device is associated with a final manufacturer or distributer (Manufacturer E, FIG. 5) of the product that is being introduced in, or is in, commerce. In another embodiment, the request can be received from a user computing device, wherein the user computing device is associated with a vendor (Vendors A-D, FIG. 5) in a supply chain. The vendor is associated with a vendor of a source material or operation in the supply chain used to form the product. The request involves a submission—albeit it is a request for a completed copy of the report or a request for preparing and submitting the report.

The request identifies the product and also includes the location of the product. Returning to FIG. 3A, at S312 the form identification module 132 identifies the product and the location named in the submission. There is no limitation made herein on how the module makes the determination. In one embodiment, the information can be transmitted directly to the module from the interface submitting the request. In another embodiment, this information can be extracted from the fields in a submission form. Further information that may be acquired or determined with the submission can include each source material or operation in a production or supply chain of the product. In this manner, the other vendors involved in the supply chain can be linked to the final product, such that a relationship between the vendors can be determined.

In one or more embodiments, the system includes functionality to match the product or location information to agency and/or regulations in the repository. Module 132 may evaluate one or more matching criteria using the product information from the vendor as input to the matching criteria. Using the product information, module 132 accesses a table corresponding to the regulated products and the agencies that regulate the products at S314. In response to the module 132 matching the product (associated with the submission) with a regulated product listed in the table, module 132 determines the compliance requirements that the product must satisfy for each regulatory agency before entering commerce at S316. The disclosure is not limited to any one approach for determining the compliance requirements.

In one embodiment, module 132 can determine the compliance requirements by identifying at least one compliance form that needs to be completed for the product marketing. This determination can be made on a vendor-by-vendor basis, whereby the vendor can be associated with a component, source material, or operation of the end-product. At S318, module 134 acquires the data fields from the repository after identifying the relevant compliance requirements. This operation involves acquiring from the superset of all data fields the corresponding requests for information, and removing any data fields that are not required by the target agencies.

Continuing at FIG. 3B, the system uses the acquired requests for information to generate a form (or questionnaire) that contains a superset of all the data required by all of the target agencies for the product or service at S320. The form population module 134 transmits the form to a user device at S322. In one embodiment, the user device can simply be a display device, whereby the module 134 displays the form to the user. At the user device, at 324 a user (e.g., an end-user) is guided through the questionnaire, whereby module 134 enables a graphic user interface to receive information associated with each data field, as inputs provided by the user. The module 134 receives the information directly from the vendor in the form of answers that correspond to the data fields at S324.

The first time that a vendor or manufacturer submits product information as a form of input is when it completes a development of the product. This information can be updated at certain junctures. For example, in one embodiment, the system includes functionality to add a new vendor to the product record in the repository. The information can further be updated when a new regulation is introduced for enforcement; when there is a change in the vendor providing a sub-component, or when a new certification or classification is required by the product distributors or consumers. Regardless, the information is received from the vendor computing or user device.

The module 134 next extracts the information corresponding with each data field from the completed form at S326. In another embodiment, the form population module 134 acquires the information stored in the repository.

The system may further include functionality to aggregate the product and/or vendor information in the repository. In one embodiment, the system may create a product record that may link all vendors that cooperate to create the product. FIG. 5 illustrates, for example, Vendors A-D and Manufacturer E cooperate to produce Product 3. In this example, a record will link Vendor A (chemical) and Vendor C (sub-part/Product 1), link Vendor B (chemical) and Vendor D (sub-part/Product 2), and link Manufacturer E and Vendors C and D (sub-parts). The record can include names, address (locations), contact information, and other information that may be used to identify the agencies with jurisdiction.

Returning to FIG. 3B, the module 134 generates a separate regulatory compliance form for each corresponding agency and vendor involved in the product launch at S328. Each form includes the data fields for the information only required by the agency or vendor associated with the form. The product information acquired via S322-S326 is used to populate the form(s) at S330. Specifically, the module 134 populates the user information in the data fields of the at least one form to generate at least one regulatory compliance report. After generating a regulatory compliance report for a source material or operation used in producing the product or service, module 134 can identify the recipients of the completed forms for transmission. There will always be information in the completed forms that is public, such as the product name. However, in certain scenarios, there may be other information that is proprietary, such as the formulas. FIGS. 5A-B illustrate, for example, that the report prepared on behalf of Vendor A for Chemical A includes proprietary information that can be communicated to Vendor C, but should be maintained in confidence for Manufacturer E. Returning to FIG. 3C, on a vendor-by-vendor basis, the module 134 selectively redacts proprietary information from the regulatory compliance report to generate a partially redacted compliance report at S330.

In one embodiment, the data fields that are stored in the repository can be classified into security and sharable levels. In response to the module 134 populating the data field with the corresponding information, the module can further redact the information from the final report, depending on the recipient of the report. In another embodiment, the vendor/manufacturer can set the level of confidentiality when it submits the information to the RCS system.

The RCS system discriminates between the recipients. Each vendor reports on its own product to the RCS system (see, FIG. 5). Then, the RCS system transmits the completed report to the target regulatory agency. For a vendor farther down the supply chain, the system can communicate the previous vendor's report or the partially redacted report. In this manner, the vendors cooperating with the reporting vendor can have access to the compliance information without having access to the proprietary information contained in the report.

This scenario is illustrated in FIG. 5. Vendor A produces Chemical A, which is used by Vendor C to product Product 1, which itself is used by Manufacturer E in forming final Product 3. Similarly, Vendor B produces Chemical B, which is used by Vendor D to product Product 2, which itself is also used by Manufacturer E in forming the final Product 3. The information on Vendor A's chemical is communicated to Vendor C, but is redacted from the report that is communicated to Manufacturer E. Further, because Manufacturer E is linked to Vendors B and D, Vendor A's proprietary information is not made viewable to those vendors as well.

The output module 138 may display the completed report, or a summary of the populated data fields corresponding to a completed report, in a user interface. The user interface may prompt a vendor to approve of a final submission of the report before transmitting the at least one regulatory compliance report to a corresponding agency computing device. At S332A, module 138 transmits the completed regulatory compliance report to the target agencies. In one embodiment, module 138 can automatically transmit the completed report to the target recipients, and further display a confirmation at the end-user computing device indicating that the regulatory compliance report had been submitted to an appropriate agency for the source material or operation.

Embodiments are contemplated by which the system includes functionality to transmit a copy of the regulatory compliance report to computing devices owned respectively by one or more vendors. In such embodiments, the output module 136 is operative to transmit the completed report or a partially redacted compliance report to a user computing device associated with a vendor farther down a supply chain at S332B.

In another embodiment, the recipients (agencies, vendors, manufacturers, etc.) can access the completed reports in the RCS system. A copy of the report is maintained in the repository and can be selectively accessed by the agency.

Furthermore, at S334 the system includes functionality that allows the recipients of the report to send results and/or requests for additional information through the RCS system to the vendor. FIGS. 5A-5B illustrates Regulatory Agencies A . . . n sending the results and/or additional requests for information to Vendors B and D. By “results”, the disclosure means the agency approval that is made after the agency evaluates the information on the product.

The output module 136 is further operative to determine errors or incomplete data fields in the populated report. In response to one of an error and incomplete data field populated in the regulatory compliance report, module 136 transmits a notification to at least one of a vendor computing device and an end-user computing device. In this manner, the vendor can submit information to the RCS system to correct or complete the report, or the end-user can prompt the vendor to do the same. In a similar manner, in response to no regulatory compliance report being generated for the source material or operation used in producing the product or service, module 136 can transmit a notification to the at least one of the vendor computing device and the end-user/manufacturer computing device. The method returns to S322 to correct any errors in the report. The method ends at S336.

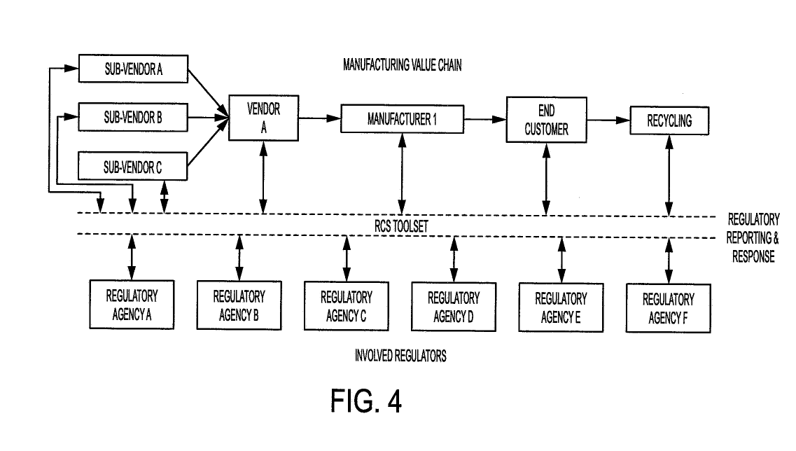

FIG. 4 is an illustrative regulatory environment according to the disclosure. FIG. 4 illustrates the relationships among various parties in a reporting structure that uses the disclosed RCS system. As viewable from the illustration, the RCS system manages the flow of data (e.g., completed reports) between the regulatory agencies and the vendors. As further viewable from the illustration, one aspect of the disclosure is that each party in communication with the RCS system is not bogged down with multiple tasks, thus simplifying the reporting scheme for the parties associated with a select product.

FIG. 5 is an illustrative reporting structure for the embodiments described in connection with the method of FIG. 3. The reporting is localized. As FIG. 5 illustrates, Vendor A reports on its own product, a chemical. Vendor A must complete a report to a regulator, but also has to communicate its information to Vendor C. Vendor C is a vendor down the supply chain, and is responsible for submitting its own report on its own contribution to the product. Vendor C and Vendor A's reports are linked in the system. Copies of these reports will also be transmitted to Manufacturer E, only the proprietary information of Vendor A will be redacted from the Vendor E's copy of Vendor A's report.

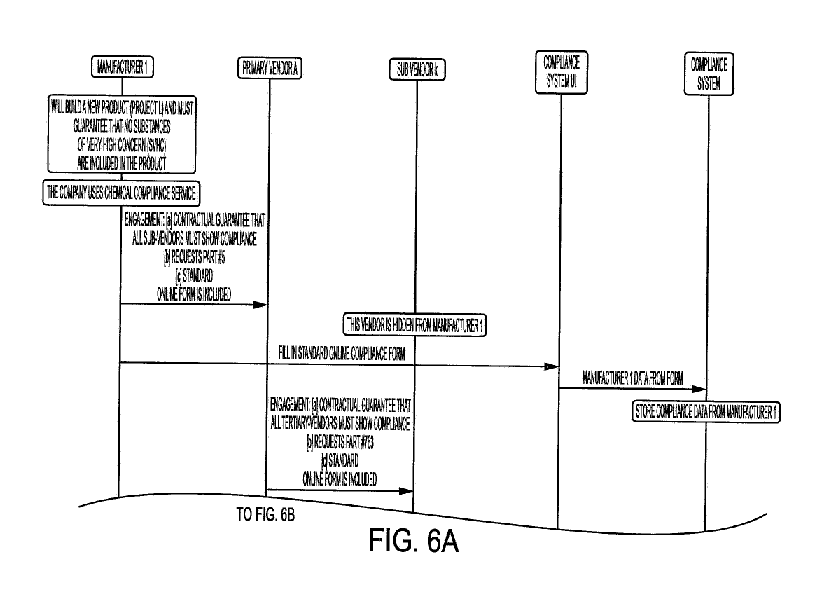

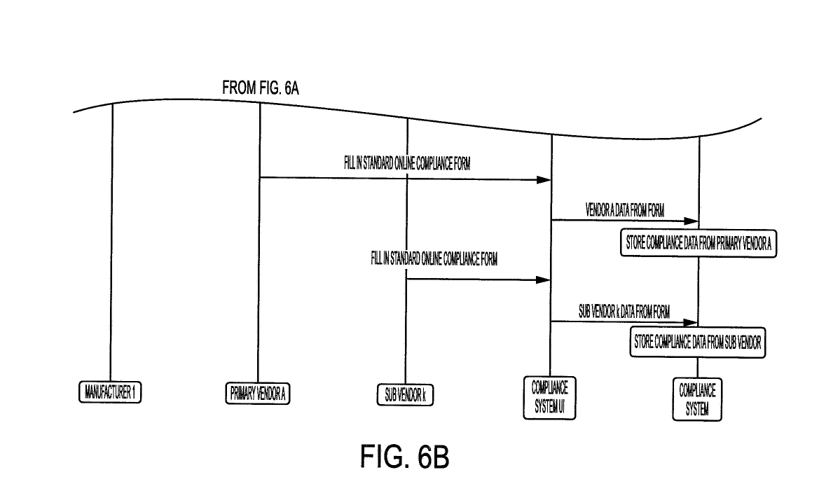

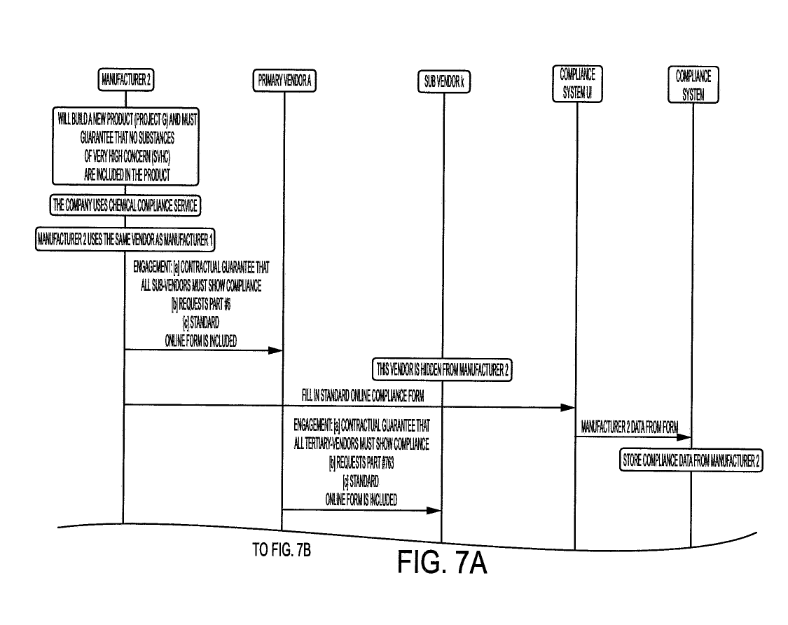

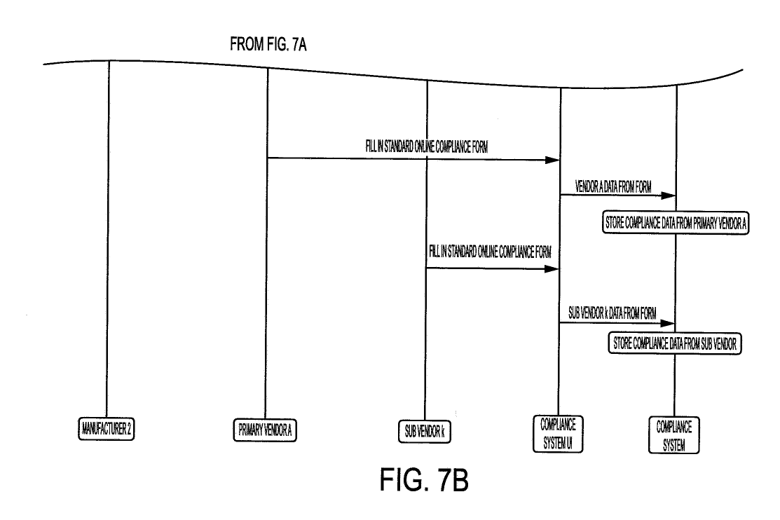

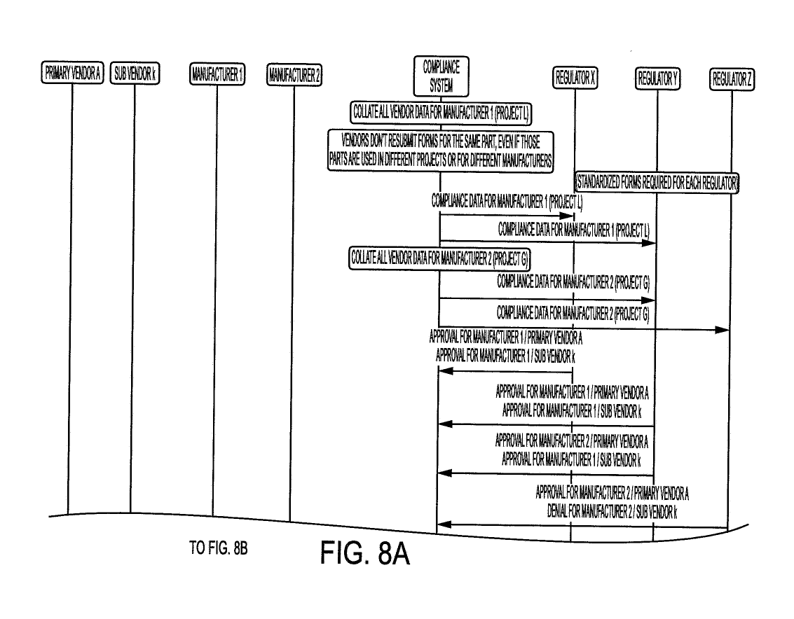

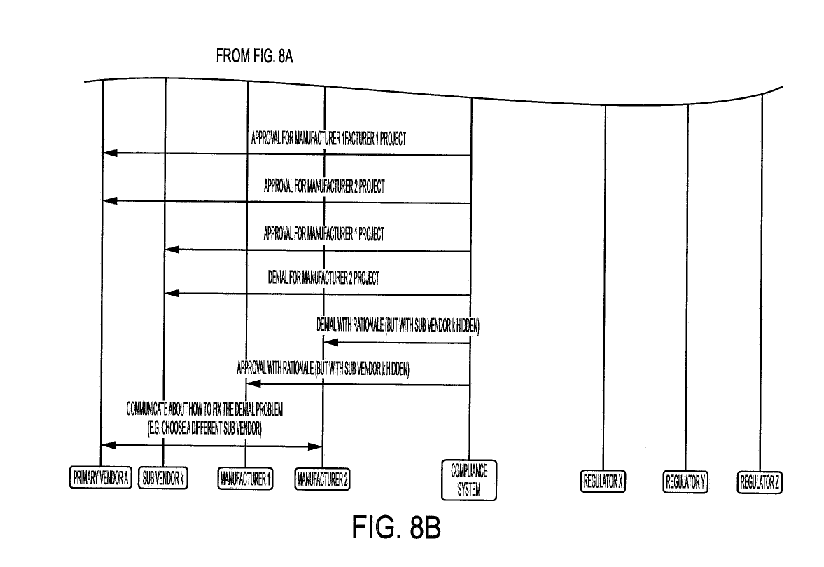

FIGS. 6-8 are sample reporting environments for illustrative purposes. In FIGS. 6 and 7 illustrate similar data gathered for Manufacturers 1 and 2. The compliance forms are populated for each manufacturer and delivered to the compliance system for storage. Further, vendors involved in manufacturing the new product also deliver forms to the system. Copies of the manufacturers' forms are also delivered to the primary vendor A, and copies of primary vendor A's forms are also delivered to Sub Vendor K. FIG. 8 illustrates the data and information being delivered to and transmitted from the compliance system. The compliance reports delivered to the system in FIGS. 6 and 7 are transmitted to the corresponding agency having jurisdiction. For example, the compliance data for Manufacturer 1 is sent to Regulatory X while the complacence data for Manufacturer 2 is sent to Regulators Y and Z. The Regulators X-Z further return approval, denial, or conditional approval/denial for the product, which is relayed by the system to the Manufacturer or Vendor.

One aspect of the disclosure is that it allows a vendor to enter a product into a new region without repeating the cumbersome task of filling out forms from the beginning. Instead, the RCS system automatically populates the correct data for the forms required by the agencies having jurisdiction in the new region. The system only requests from the vendor any supplemental data that is absent in the previously completed reports, but is required by the new region.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for populating regulatory forms, comprising:
accessing a repository comprising a plurality of regulatory forms each corresponding to a participating agency, wherein each of the plurality of forms comprises a plurality of data fields;
at a server computer in communication with the repository, processing each form in the repository to generate a superset of all data fields required by all of the agencies;
receiving from a user interface a new or renewing product/service submission;
from the product or service identified in the submission, determining each target regulatory agency's compliance requirements that the product or service must satisfy before entering commerce;
generating at least one form corresponding to the requirements;
populating user information in the data fields of the at least one form to generate at least one regulatory compliance report; and
transmitting the at least one regulatory compliance report to a corresponding agency computing device.

2. The method of claim 1, wherein the user interface is in communication with the server computer, the user interface belonging to a computing device selected from a group comprising:
a vendor computing device, wherein the vendor computing device is associated with a vendor of a source material or operation in a supply chain used to form the product or service;
a user computing device, wherein the user computing device is associated with a second vendor farther down the supply chain;
an end-user computing device, wherein the end-user computing device is associated with a final manufacturer or distributer of the product or service;
an agency computing device, wherein the agency computing device is associated with an agency regulating or certifying the product; and
a combination of the above.

3. The method of claim 1 further comprising:
from the product or service identified in the submission, determining each source material/operation in a production/supply chain of the product or service; and
determining the each target regulatory agency's compliance requirements for the each source material or operation.

4. The method of claim 3 further comprising:
identifying a product named in the new or renewing product or service submission;
accessing a table of corresponding regulated products and agencies that regulate the products;
comparing the product to the regulated products;
in response to the product matching a regulated product, determining the compliance requirements that the product or service must satisfy for the each target regulatory agency before entering commerce;
generating a form that contains the superset of all data fields required by all of the target regulatory agencies for the product or service;
transmitting the form to a user device for displaying the data fields; and
enabling a receipt of information from the user device, where each information is associated with a data field.

5. The method of claim 4 further comprising:
from the information associated with the superset of data fields, generating a separate form for the each target regulatory agency, wherein each separate form contains a subset of data required by a select agency;
transmitting to the each target regulatory agency only the form containing the subset of data that the each target regulatory agency needs to assess the product or service for marketing approval.

6. The method of claim 1 further comprising:
transmitting to an end-user computing device a confirmation that a regulatory compliance report has been submitted to an appropriate agency for the source material or operation.

7. The method of claim 1 further comprising:
in response to one of an error and incomplete data field populated in the regulatory compliance report generated for a source material or operation used in producing the product or service, transmitting a notification to at least one of a vendor computing device and an end-user computing device; and
in response to no regulatory compliance report being generated for the source material or operation used in producing the product or service, transmitting the notification to the at least one of the vendor computing device and the end-user computing device.

8. The method of claim 1 further comprising:
after generating a regulatory compliance report for a source material or operation used in producing the product or service, transmitting the regulatory compliance report to computing devices owned respectively by one or more vendors;
on a vendor-by-vendor basis, selectively redacting proprietary information from the regulatory compliance report to generate a partially redacted compliance report; and,
transmitting the partially redacted compliance report to a user computing device, wherein the user computing device is associated with a vendor farther down a supply chain.

9. The method of claim 1 further comprising:
before the populating, acquiring from the superset of all data fields corresponding requests for information;
transmitting a request to a remote computing device for the information; and
receiving the information from the user interface in the form of answers from the remote computing device.

10. The method of claim 1 further comprising:
before generating the superset of all data fields, extracting a request for information corresponding to each data field from the plurality of regulatory forms;
removing duplicate requests to generate the superset of all data fields; and
removing any data fields not required by the target regulatory agencies.

11. A computer program product comprising a non-transitory recording medium storing instructions, which when executed on a computer, cause the computer to perform the method of claim 1.

12. A system for populating regulatory forms, comprising:
a repository comprising a plurality of regulatory forms each corresponding to a participating agency, wherein each of the plurality of forms comprises a plurality of data fields;
a server computer in communication with the repository, the server computer including a memory storing instructions and a processor programmed to execute the instructions, the processor being operative to:
process each form in the repository to generate a superset of all data fields required by all of the agencies;
receive from a user interface a new or renewing product or service submission;
from the product or service identified in the submission, determine each target regulatory agency's compliance requirements that the product or service must satisfy before entering commerce;
determine at least one form corresponding to the requirements;
acquire from the repository the at least one form;
populate user information in the data fields of the at least one form to generate at least one regulatory compliance report; and
transmit the at least one regulatory compliance report to a corresponding agency computing device.

13. The system of claim 12, wherein the user interface is in communication with the server computer, the user interface belonging to a computing device selected from a group comprising:
a vendor computing device, wherein the vendor computing device is associated with a vendor of a source material or operation in a supply chain used to form the product or service;
a user computing device, wherein the user computing device is associated with a second vendor farther down the supply chain;
an end-user computing device, wherein the end-user computing device is associated with a final manufacturer or distributer of the product or service;
an agency computing device, wherein the agency computing device is associated with an agency regulating or certifying the product; and
a combination of the above.

14. The system of claim 12, wherein the processor is further operative to:
from the product/service identified in the submission, determine each source material or operation in a production or supply chain of the product or service; and
determine compliance requirements for the each source material or operation.

15. The system of claim 14, wherein the processor is further operative to:
identify a product named in the new or renewing product or service submission;
access an associated table stored in a database in communication with the server computer, the table corresponding regulated products and agencies that regulate the products;
compare the product to the regulated products;
in response to the product matching a regulated product, determine the compliance requirements that the product or service must satisfy for the each regulatory agency before entering commerce;
generate a form that contains a superset of all data fields required by all of the target regulatory agencies for the product or service;
transmit the form to a user device for displaying the data fields; and
enabling a receipt of information from the user device, where each information is associated with a data field.

16. The system of claim 15, wherein the processor is further operative to:
from the information associated with the superset of data fields, generate a separate form for the each target regulatory agency, each separate form containing a subset of the information which is required by a corresponding agency; and
transmit to the each target regulatory agency only the form containing the subset of the information that the corresponding agency needs to assess the product or service for marketing approval.

17. The system of claim 15, wherein the processor is further operative to:
transmit to an end-user computing device a confirmation that a regulatory compliance report has been submitted to an appropriate agency for the source material or operation.

18. The system of claim 15, wherein the processor is further operative to:
in response to one of an error and incomplete data field in the regulatory compliance report generated for a source material or operation used in producing the product or service, transmit a notification to at least one of a vendor computing device and an end-user computing device; and
in response to no regulatory compliance report being generated for the source material or operation used in producing the product or service, transmit the notification to the at least one of the vendor computing device and the end-user computing device.

19. The system of claim 12, wherein the processor is further operative to:
transmit the regulatory compliance report to computing devices owned respectively by one or more vendors;
on a vendor-by-vendor basis, selectively redact proprietary information from the regulatory compliance report to generate a partially redacted compliance report; and,
transmit the partially redacted compliance report to a user computing device, wherein the user computing device is associated with a vendor farther down a supply chain.

20. The system of claim 12, wherein the processor is further operative to:
before the populating, acquire from the superset of all data fields corresponding requests for information;
transmit a request to a remote computing device for the information; and
receive the information from the user interface in the form of answers from the remote computing device.

21. The system of claim 12, wherein the processor is further operative to:
before generating the superset of all data fields, extract a request for information corresponding to each data field from the plurality of regulatory forms;
remove duplicate requests to generate the superset of all data fields; and
removing any data fields not required by the target regulatory agencies.
